(19) United States
(12) Patent Application Publication
(10) Pub. No.: US 2018/0202836 A1
(43) Pub. Date: Jul. 19, 2018

(54) POSITION SENSOR

(71) Applicant: HITACHI AUTOMOTIVE SYSTEMS, LTD., Ibaraki (JP)

(72) Inventors: Nobuaki GORAI, Hitachinaka (JP); Takeshi KATO, Hitachinaka (JP); Junji ONOZUKA, Hitachinaka (JP)

(73) Assignee: HITACHI AUTOMOTIVE SYSTEMS, LTD., Ibaraki (JP)

(21) Appl. No.: 15/743,957

(22) PCT Filed: Jul. 27, 2016
(86) PCT No.: PCT/JP2016/071955

§ 371 Date: Jan. 11, 2018

(30) Foreign Application Priority Data
Aug. 31, 2015 (JP) 2015-169984

(51) Int. Cl. G01D 5/14; F16B 21/18; G01D 11/24; G01B 7/00

(52) U.S. Cl. CPC G01D 5/145; G01B 7/003; G01D 11/245; F16B 21/18

(57) ABSTRACT

The purpose of the present invention is to provide a position sensor capable of improving the mounting characteristics of a magnet to a moving body in the axial direction of a shaft or the like. In order to achieve the purpose, this position sensor is provided with a magnetic force sensor and a target mounted on a moving body that moves in the axial direction, wherein the target has a magnet and a magnet base for holding the magnet, and the magnet base has a magnet-holding section and a securing section to the moving body that are integrally formed.

### TECHNICAL FIELD

The present invention relates to a position sensor.

### BACKGROUND ART

A structure for installing a magnetic position sensor is discussed in PTL 1. The magnet installation structure of PTL 1 has a magnet, a holder, and a shaft. The holder is formed in a partially truncated cylindrical shape. The shaft has a hollow, and the magnet is disposed in the hollow of the shaft, so that the magnet is easily fixed in an accurate position by fitting the holder perpendicularly to the axial direction of the shaft.

### CITATION LIST

### Patent Literature

PTL 1: Japanese Unexamined Patent Application Publication No. 2005-9996

### SUMMARY OF INVENTION

### Technical Problem

However, in the structure for fitting the magnet into the shaft using the holder, the magnet may move perpendicularly to the axial direction of the shaft or in the axial direction of the shaft if a slight gap exists between the magnet and the holder. Therefore, a position between the shaft and the magnet may change disadvantageously.

In addition, in an axial insertion shape, it is difficult to dispose other structural components in the insertion direction. Therefore, it is difficult to secure freedom in the installation structure.

In view of the aforementioned problems, an object of the present invention is to provide a position sensor capable of improve installability for installing the magnet in a movable object in the axial direction, such as the shaft.

### Solution to Problem

In order to achieve the aforementioned object, according to the present invention, there is provided a position sensor including a magnetic sensor and a target installed in a movable object, wherein the target has a magnet and a magnetic base that holds the magnet, and the magnetic base has a magnet holding portion and a fixing portion for fixation to the movable object, the magnet holding portion and the fixing portion being formed integrally.

### Advantageous Effects of Invention

According to the present invention, it is possible to easily install the magnet in the movable object that moves in the axial direction, such as the shaft.

### BRIEF DESCRIPTION OF DRAWINGS

FIG. 1 is an installation diagram illustrating a first embodiment.

FIG. 2 is a perspective view illustrating the first embodiment.

FIG. 3 is a side view illustrating the first embodiment.

FIG. 4 is a front view illustrating the first embodiment.

FIG. 5 is a perspective view illustrating a second embodiment.

FIG. 6 is an exploded perspective view illustrating the second embodiment.

FIG. 7 is a side view and an exploded side view illustrating the second embodiment.

FIG. 8 is an exploded perspective view illustrating a modification of the second embodiment.

FIG. 9 is an exploded side view illustrating a modification of the second embodiment.

FIG. 10 is a side view illustrating a modification of the second embodiment.

FIG. 11 is a perspective view illustrating a third embodiment.

FIG. 12 is an exploded perspective view illustrating the third embodiment.

FIG. 13 is a side view and an exploded side view illustrating the third embodiment.

FIG. 14 is a perspective view illustrating a modification of the third embodiment.

FIG. 15 is an exploded perspective view illustrating a modification of the third embodiment.

FIG. 16 is a side view and an exploded side view illustrating a modification of the third embodiment.

FIG. 17 is a front view illustrating a shaft according to the first to third embodiments.

FIG. 18 is a side view illustrating a shaft according to the first to third embodiments.

FIG. 19 is a side view illustrating a shaft according to a modification of the first to third embodiments.

FIG. 20 is a front view illustrating a shaft according to a modification of the first to third embodiments.

FIG. 21 is a top plan view illustrating a shaft according to a modification of the first to third embodiments.

FIG. 22 is a side view illustrating a shaft according to a modification of the first to third embodiments.

FIG. 23 is a front view illustrating a shaft according to a modification of the first to third embodiments.

FIG. 24 is a top plan view illustrating a shaft according to a modification of the first to third embodiments.

FIG. 25 is an exploded perspective view illustrating a fourth embodiment.

FIG. 26 is a side view illustrating a fourth embodiment.

FIG. 27 is a front view illustrating the fourth embodiment.

FIG. 28 is a perspective view for installation according to the fourth embodiment.

FIG. 29 is an exploded perspective view for installation according to the fourth embodiment.

FIG. 30 is an exploded side view and a side view for installation according to the fourth embodiment.

FIG. 31 is a top plan view for installation according to the fourth embodiment.

FIG. 32 is a perspective view illustrating a shaft according to the fourth embodiment.

FIG. 33 is a side view illustrating a shaft according to the fourth embodiment.

FIG. 34 is a front view illustrating a shaft according to the fourth embodiment.

FIG. 35 is a top plan view illustrating a shaft according to the fourth embodiment.

FIG. 36 is a perspective view for installation according to a fifth embodiment.

FIG. 37 is a side view for installation according to the fifth embodiment.

FIG. 38 is a perspective view illustrating a shaft according to the fifth embodiment.

FIG. 39 is a side view illustrating a shaft according to the fifth embodiment.

FIG. 40 is a top plan view illustrating a shaft according to the fifth embodiment.

FIG. 41 is a perspective view for installation according to a sixth embodiment.

FIG. 42 is a side view for installation according to the sixth embodiment.

FIG. 43 is a perspective view illustrating a shaft according to the sixth embodiment.

FIG. 44 is a side view illustrating a shaft according to the sixth embodiment.

FIG. 45 is a top plan view illustrating a shaft according to the sixth embodiment.

FIG. 46 illustrates an example of installing a position sensor according to the invention in a movable object.

FIG. 47 illustrates an example of installing a position sensor according to the invention in a movable object.

FIG. 48 illustrates an example of installing a position sensor according to the invention in a movable object.

FIG. 49 illustrates an example of installing a position sensor according to the invention in a movable object.

FIG. 50 illustrates an example of installing a position sensor according to the invention in a movable object.

FIG. 51 illustrates an example of installing a position sensor according to the invention in a movable object.

### DESCRIPTION OF EMBODIMENTS

### First Embodiment

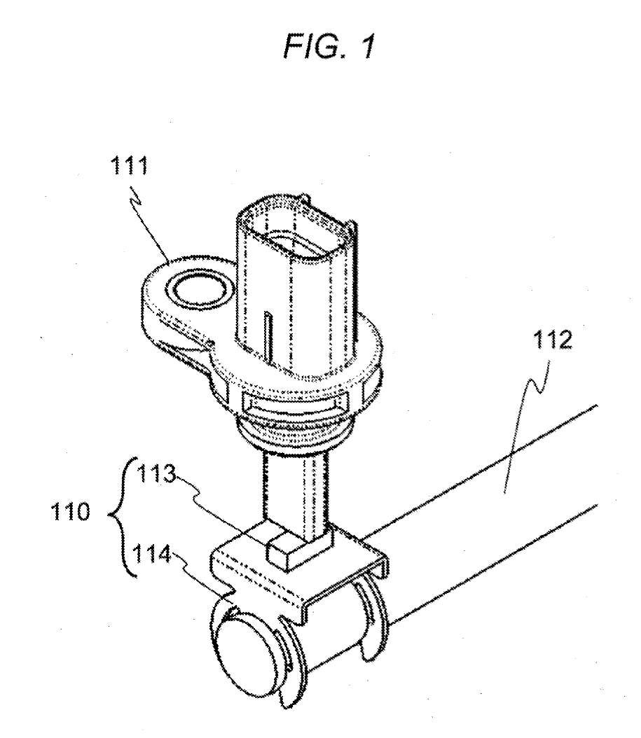

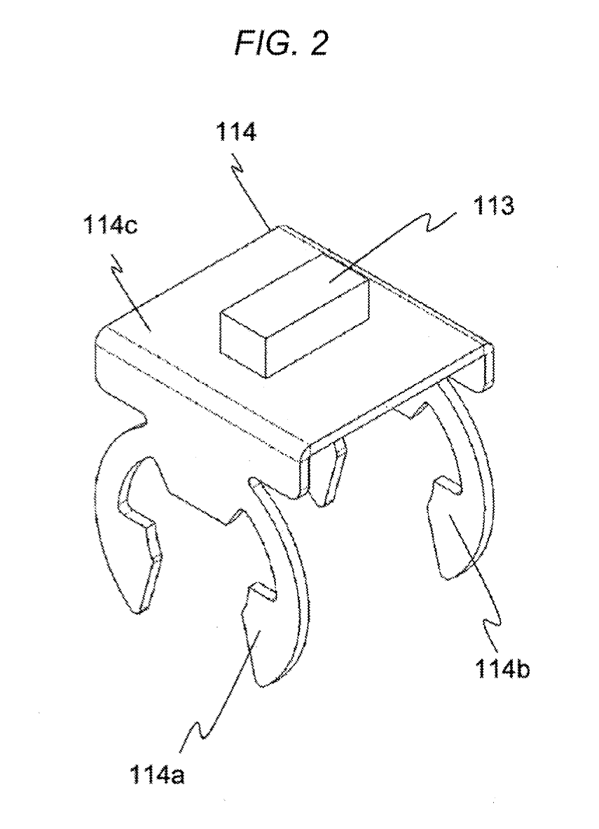

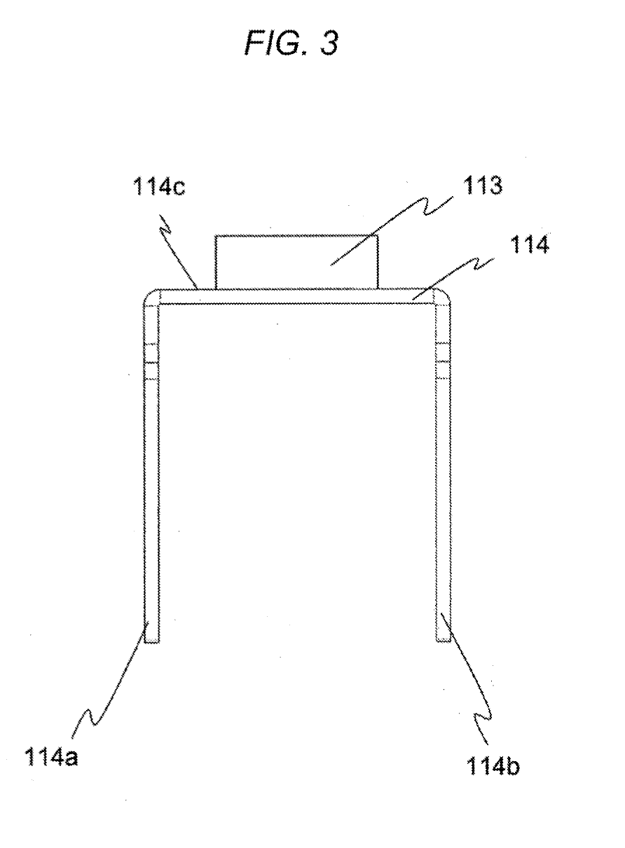

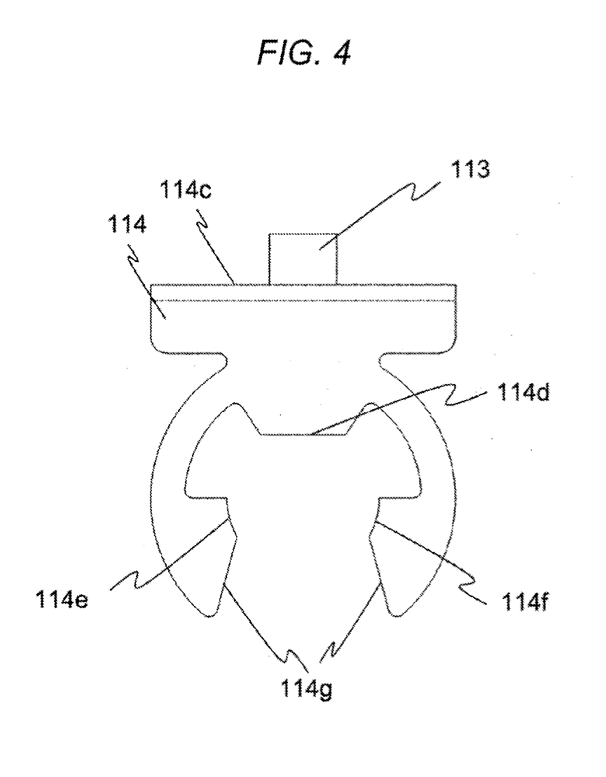

A first embodiment according to the invention will be described with reference to FIGS. 1 to 4.

A position sensor according to this embodiment has a target 110 installed in a movable object 112 moving in an axial direction and a magnetic sensor 110 for detecting a movement of the target 110. Here, according to this embodiment, the movable object 112 will be described as a shaft by way of example.

The magnetic sensor 110 includes, for example, a sensor using a Hall effect element or a sensor using a GMR element.

The target 110 has a magnet 113 for generating a magnetic flux and a magnetic base 114 for holding the magnet.

The magnetic base 114 has a structure in which a first fixing portion 114a, a second fixing portion 114b, and a magnet holding portion 114c are integrally formed. The first and second fixing portions 114a and 114b are arranged side by side along an axial direction (in other words, movement direction) of the movable object 112. The first and second fixing portions 114a and 114b are provided axially outward of an area where the magnet 113 of the magnet holding portion 114c is mounted.

The first and second fixing portions 114a and 114b have a partially opened ring shape in order to allow installation perpendicular to the axial direction of the movable object 112.

The first fixing portion is shaped to have first, second, and third contact portions 114d, 114e, and 114f coming into contact with the movable object 112. The first to third contact portions are formed such that centers of each contact portion coming into contact with the movable object 112 form an equilateral triangle.

The first contact portion 114d is formed apart from the opening and has a flat portion. The second and third contact portions 114e and 114f are formed in the opening side of the first fixing portion a to match a circumferential shape (side shape) of the movable object 112. If the movable object 112 has a cylindrical shape, the circumferential shape is an arc shape.

The first fixing portion 114a has a non-contact portion that does not come into contact with the movable object 112 between the first and second contact portions 114d and 114e. Similarly, a non-contact portion that does not come into contact with the movable object 112 is also provided between the first and third fixing portions 114d and 114f. In other words, the first fixing portion 114a has a region having a cross-sectional area smaller than that of each contact portion.

In addition, the first fixing portion 114a is tapered such that a shape of its opening 114g is gradually narrowed from the opening end toward the inside.

The second fixing portion may have the same shape as that of the first fixing portion.

The effects of this embodiment will be described.

The target 110 can be installed in the shaft serving as a movable object using the first and second fixing portions 114a and 114b integrated into the magnet holding portion 114c. For this reason, according to this embodiment, the target can be installed in the shaft serving as a sensing target without using a fastening part such as a screw.

In addition, the first and second fixing portions 114a and 114b are partially opened ring-shaped fixing portions. Therefore, they can be easily installed from the side direction of the movable object 112.

In addition, since the first fixing portion is shaped to fix the movable object in three portions including the first to third contact portions, it is possible to prevent a positional deviation in a rotational direction. In particular, if the center points of each contact portion are formed in an equilateral triangle shape, a stress generated during installation becomes symmetric with respect to a center of the movable object 112 three times, so that a rotational stress is cancelled.

In addition, one of the three contact portions apart from the opening is shaped to have a flat portion, and the opening side matches the circumferential shape of the shaft. For this reason, it is possible to improve insertion easiness (installability) to the shaft and more effectively suppress a positional deviation in the rotational direction using the flat portion.

A diameter of the shaft may change when the shaft is inserted in the axial direction. In this case, it is difficult to promote insertion of the magnetic base and adherence to the shaft. However, according to this embodiment, even when the diameter of the shaft changes between a tip portion and a portion where the magnet is to be installed and the portion to be installed, the magnetic base can be inserted from the direction perpendicular to the shaft. Therefore, it is possible to secure adherence or installability between the shaft and the magnetic base. Since the non-contact portion has a cross-sectional area smaller than that of the contact portion, it can be easily deformed. Therefore, it is possible to further improve installability at the time of insertion.

In addition, since the second and third installation portions are formed on an arc that matches the circumferential shape of the shaft, this change in the diameter can be absorbed by deformation of the non-contact portion even when the diameter of the shaft changes.

In addition, since the second and third fixing portions have an arc shape that matches the circumferential shape of the shaft, it is possible to secure adherence between the shaft and the contact portion even when the diameter changes.

In addition, since the opening 114g has a tapered shape, it is possible to prevent a point-to-surface contact in which the tip of the first fixing portion 114a comes into contact with the movable object 112. In addition, since the first fixing portion 114a and the movable object 112 make a surface-to-surface contact, it is possible to disperse a stress applied when the target 110 is inserted into the movable object. Therefore, there is no need to insert the target 110 by applying a force more than necessary.

In addition, by forming the first and second fixing portions in the same shape, it is possible to further improve installability. In addition, since they have the same shape, the same force is applied to the first and second fixing portions during and after the installation. Therefore, it is possible to prevent a rotational or distortional force from being applied to the target 110 and further improve installability and positional accuracy of the target 110 to the movable object 112. Note that, by forming the second fixing portion 114b in a shape different from that of the first fixing portion 114a, it is possible to easily recognize the installation direction.

### Second Embodiment

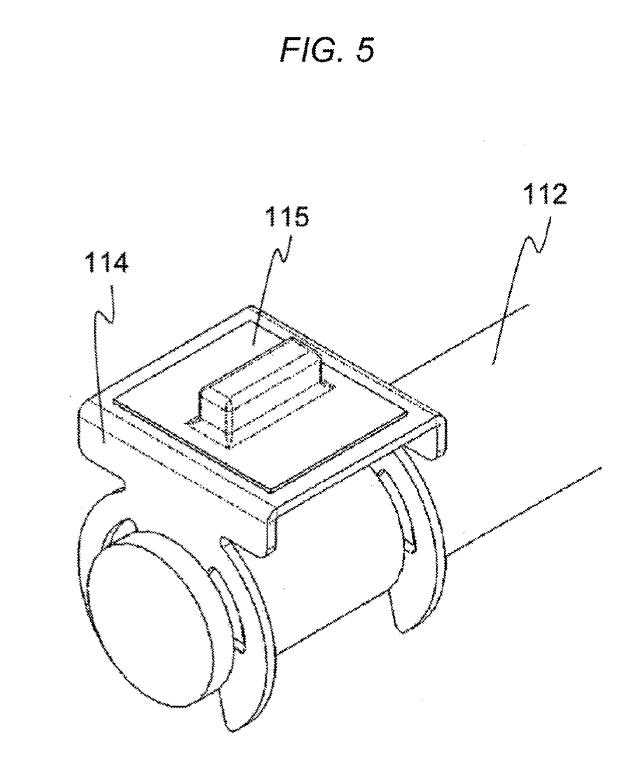

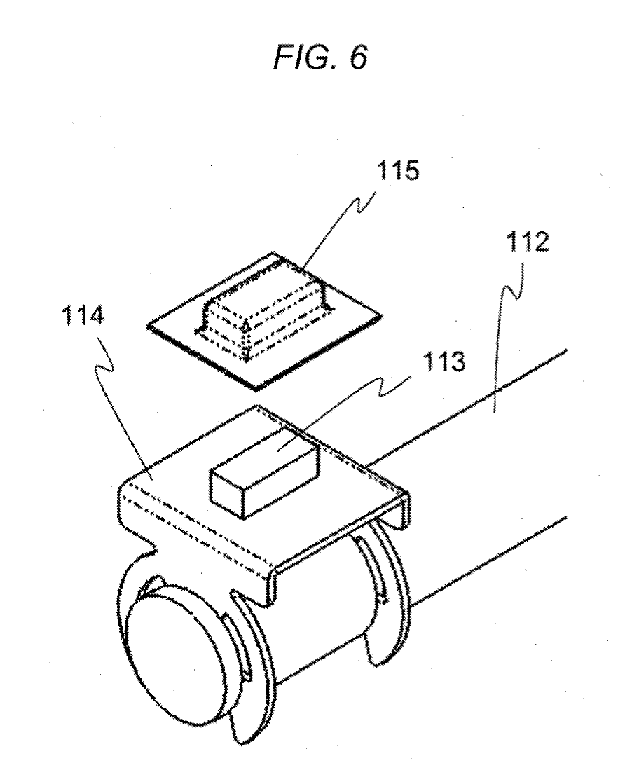

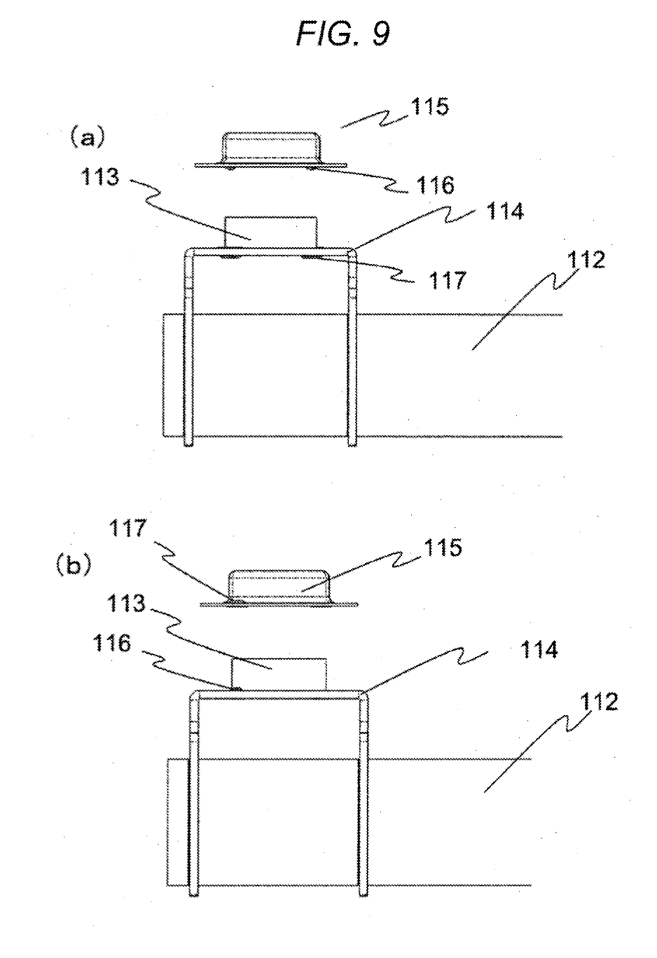

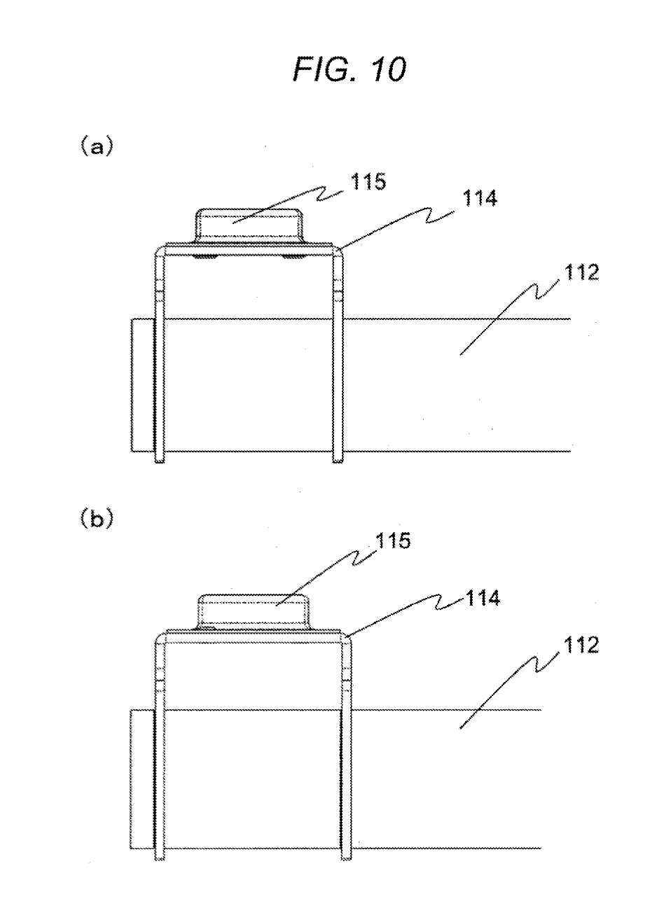

A second embodiment of the present invention will be described with reference to FIGS. 5 to 10. Note that like reference numerals denote like elements as in the first embodiment, and they will not be described repeatedly.

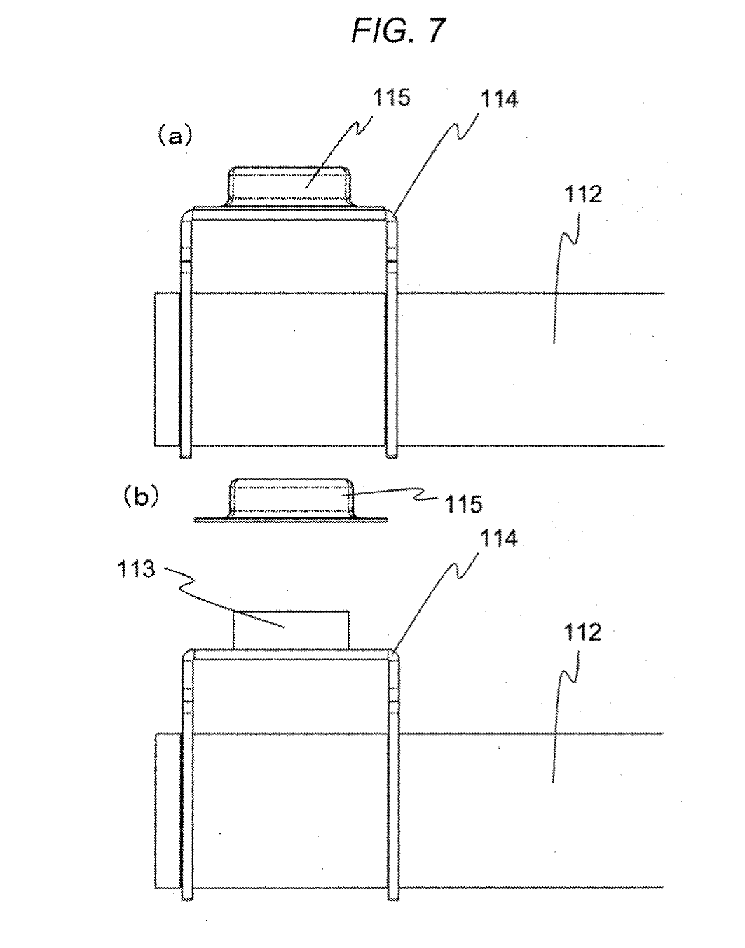

As illustrated in FIGS. 5 and 7, a position sensor according to this embodiment further has a base cover 115 for protecting the magnet 113. The base cover 115 is fixed to the magnetic base 114 through welding or the like. The base cover 115 has a housing hollow for housing the magnet 113.

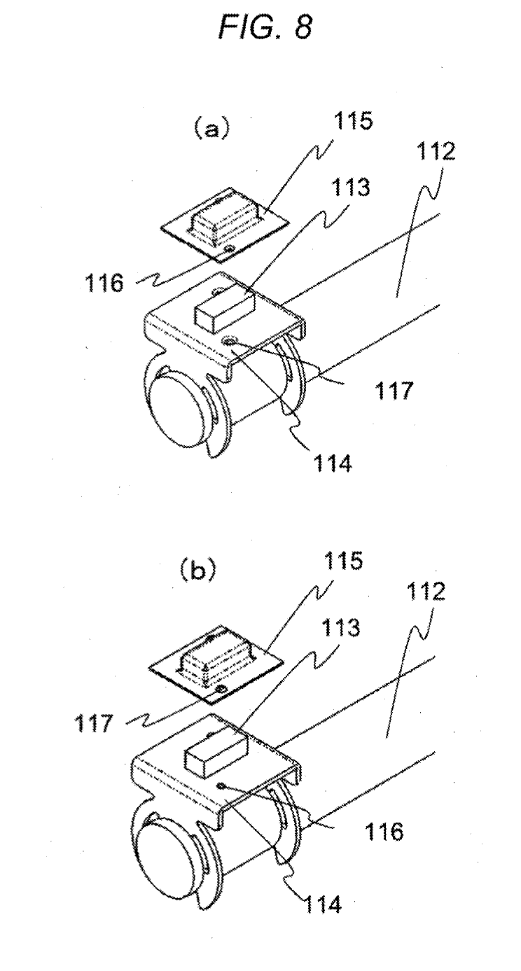

If a protrusion and a hollow for positioning are formed in the magnetic base 114 and the base cover 115 as illustrated in the modification of FIGS. 8 to 10, positioning is facilitated preferably. In this case, as illustrated in FIGS. 8a, 9a, and 10a, the positioning protrusion may be provided in the base cover 115, and the positioning hollow may be provided in the magnetic base 114. In addition, as illustrated in FIGS. 8b, 9b, and 10b, the positioning hollow 117 may be provided in the base cover 115, and the positioning protrusion 116 may be provided in the magnetic base.

According to this embodiment, the magnet 113 is protected by the base cover 115. Therefore, it is possible to further improve reliability.

### Third Embodiment

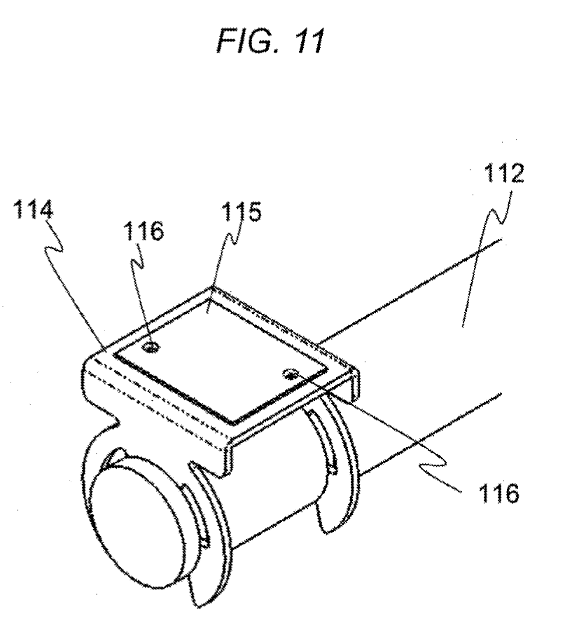

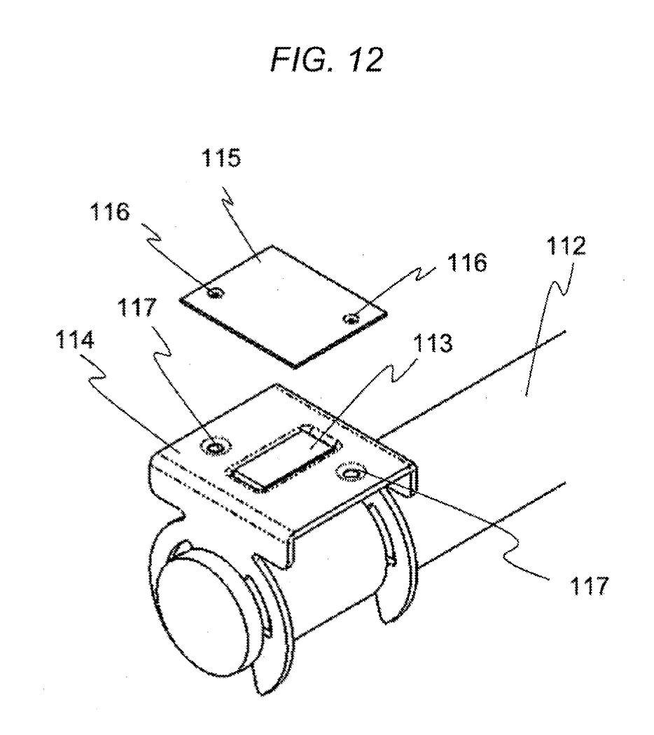

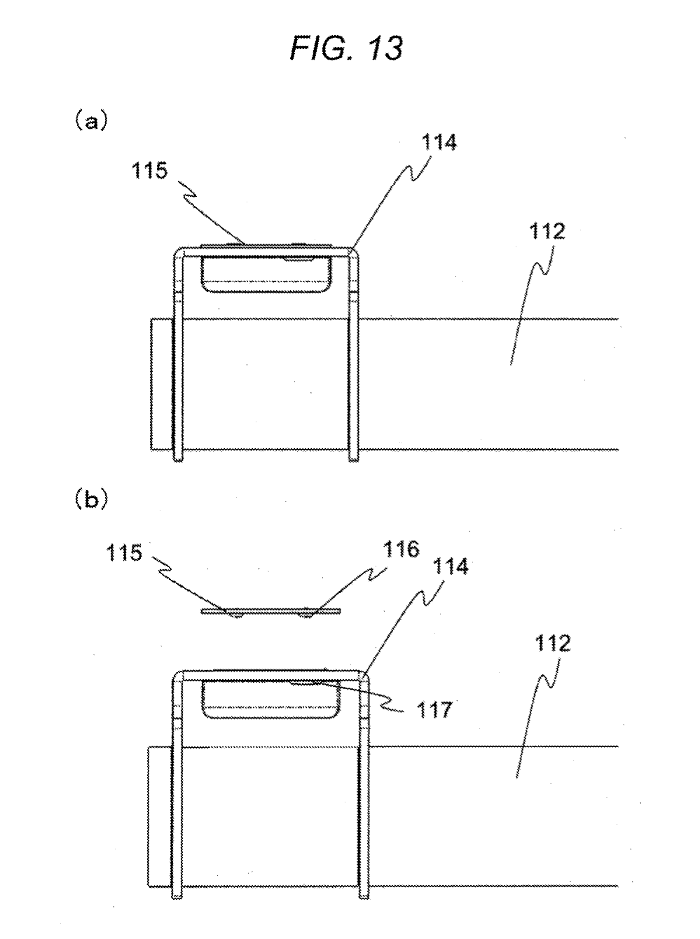

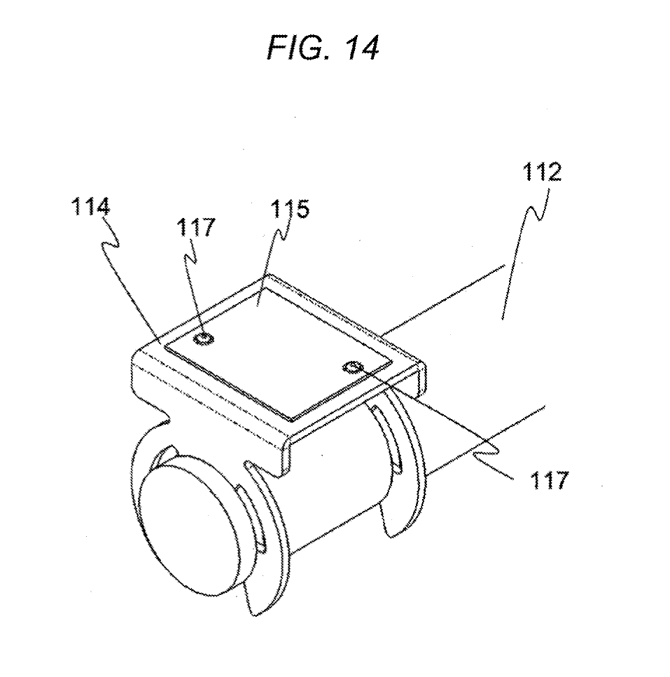

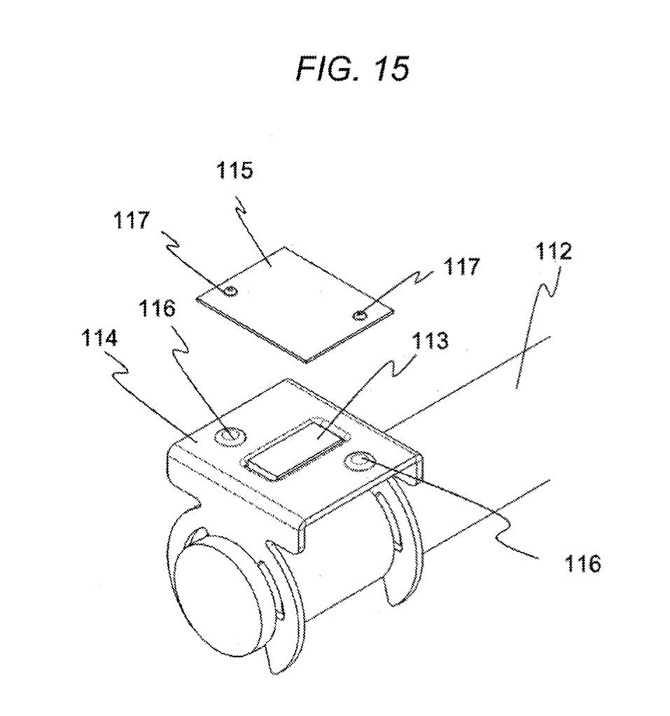

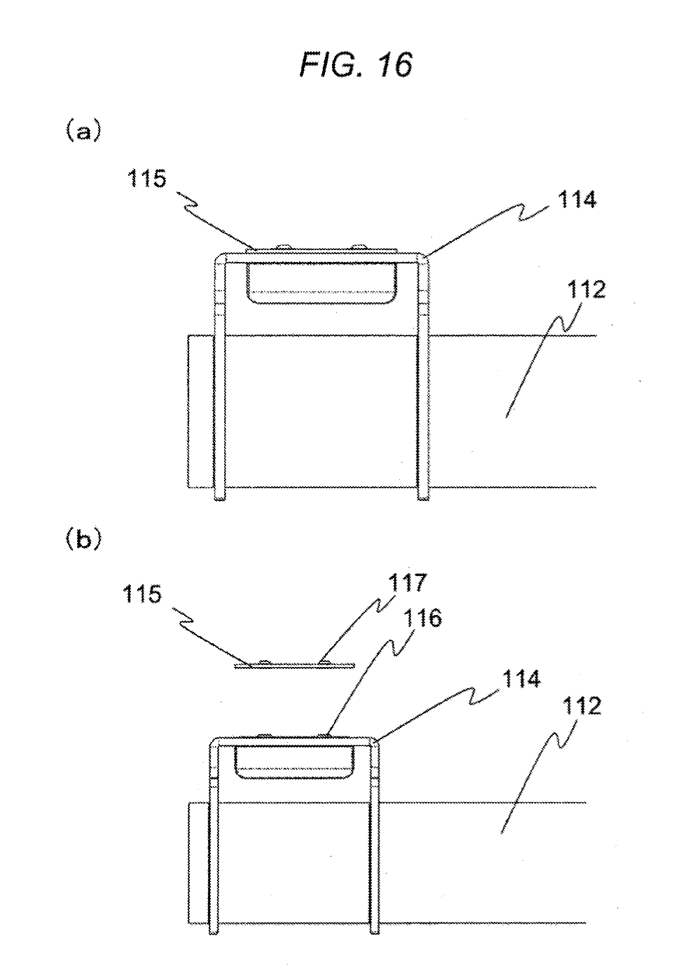

A third embodiment of the present invention will be described with reference to FIGS. 11 to 16. Note that like reference numerals denote like elements as in the first and second embodiments, and they will not be described repeatedly.

The third embodiment of the present invention is different from the second embodiment in that the housing hollow for housing the magnet in the second embodiment is formed in the magnetic base side.

Since the magnet 113 is housed in the hollow provided in the magnetic base 114, it is possible to hold the magnet 113 without increasing the height of the target 110. Therefore, it is possible to miniaturize the target 110 as a whole.

[Shaft Structure]

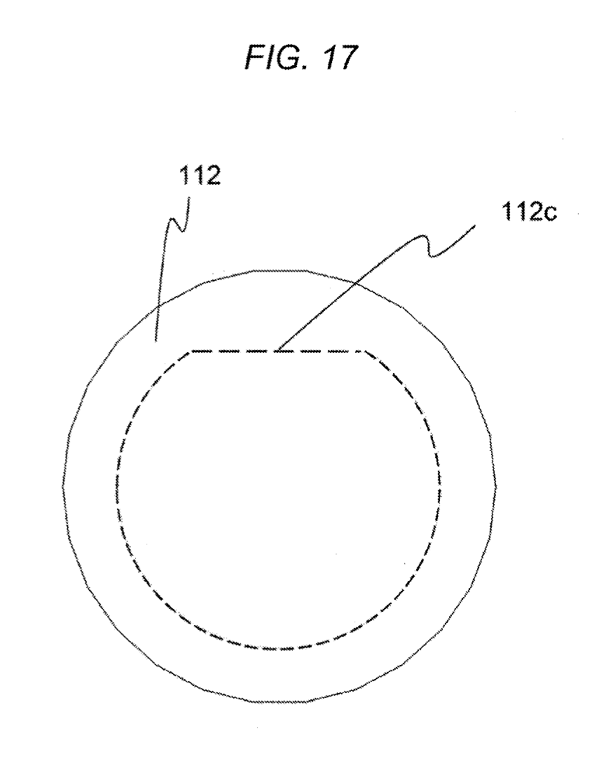

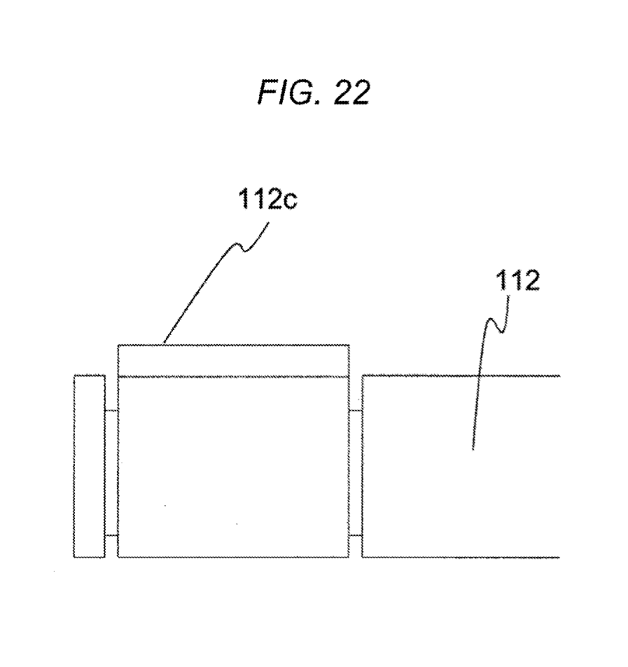

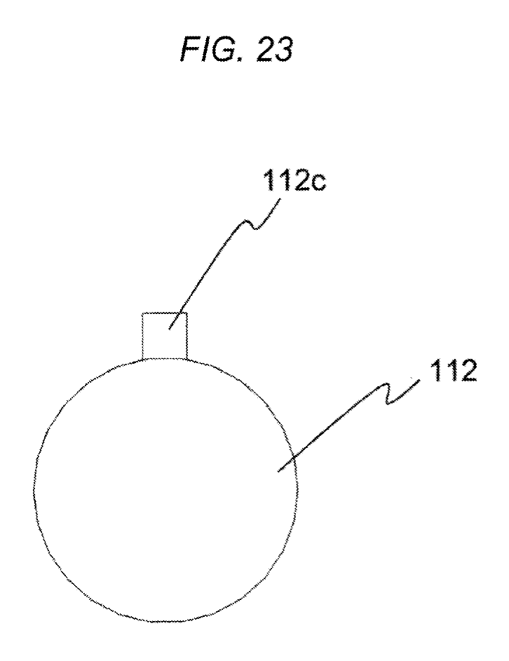

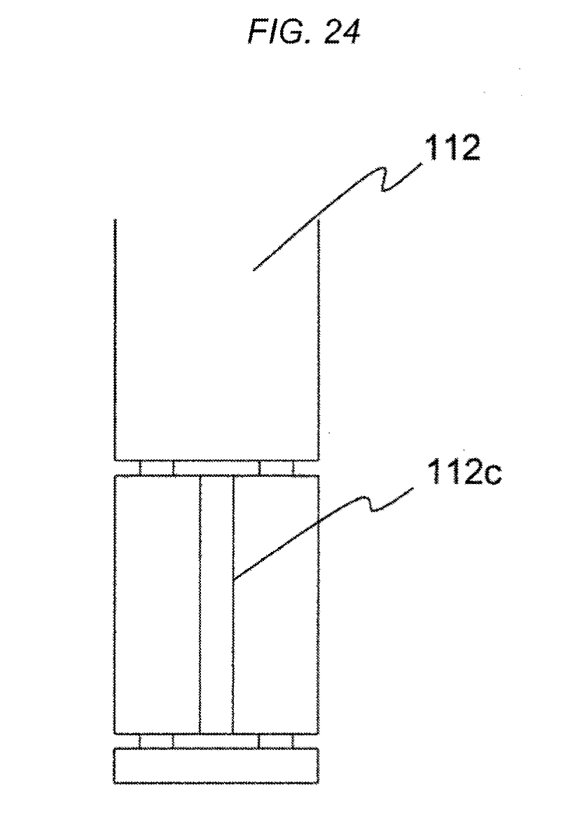

Next, a structure of the movable object 112 for installing the position sensor according to the first to third embodiments will be described with reference to FIGS. 17 to 24. An exemplary shaft will be described as an example of the movable object 112.

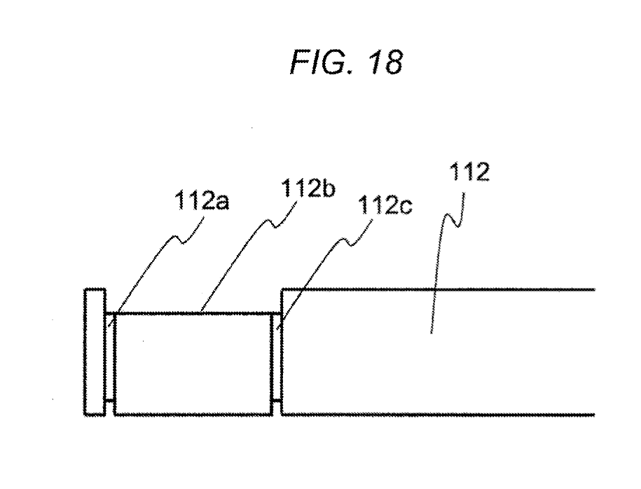

As illustrated in FIGS. 17 and 18, the shaft 112 is provided with first and second grooves 112a and 112b along a circumferential direction. A truncated portion 112c formed by cutting a part of the side surface is provided on the area including the first and second grooves on the side surface of the shaft 112.

The target 110 is fixed to the shaft 112 by fitting the first fixing portion 114a into the first groove 112a and fitting the second fixing portion 114b into the second groove 112b.

In addition, the first contact portion 114d of the first fixing portion 114a comes into contact with the truncated portion 112c provided in the shaft 112 (in other words, the flat portion).

When the second fixing portion 114b is formed similarly to the first fixing portion 114a, the first contact portion 114d comes into contact with the truncated portion 112c as in the first fixing portion 114a.

The effects of the aforementioned structure will be described below.

By fitting the first and second fixing portions 114a and 114b having a ring shape into the first and second grooves 112a and 112b provided in the shaft 112, it is possible to suppress a positional deviation of the target 110 in the axial direction. In addition, since the target 110 can be installed while being guided by this groove, installability is improved.

Since the first contact portion 114d having a flat portion and the truncated portion come into contact with each other, it is possible to suppress a positional deviation in the rotational direction.

In addition, since the holding portion of the magnetic base is fixed to the flattened portion of the shaft 112, it is possible to easily recognize a position where the magnet is to be fixed.

When the second fixing portion 114b is formed similarly to the first fixing portion 114a, the first contact portion 114d comes into contact with the truncated portion (flat portion) in two positions. Therefore, it is possible to further suppress a positional deviation in the rotational direction.

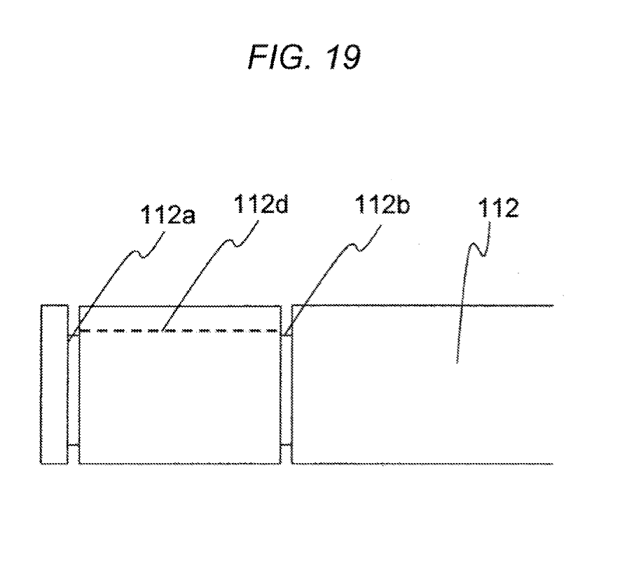

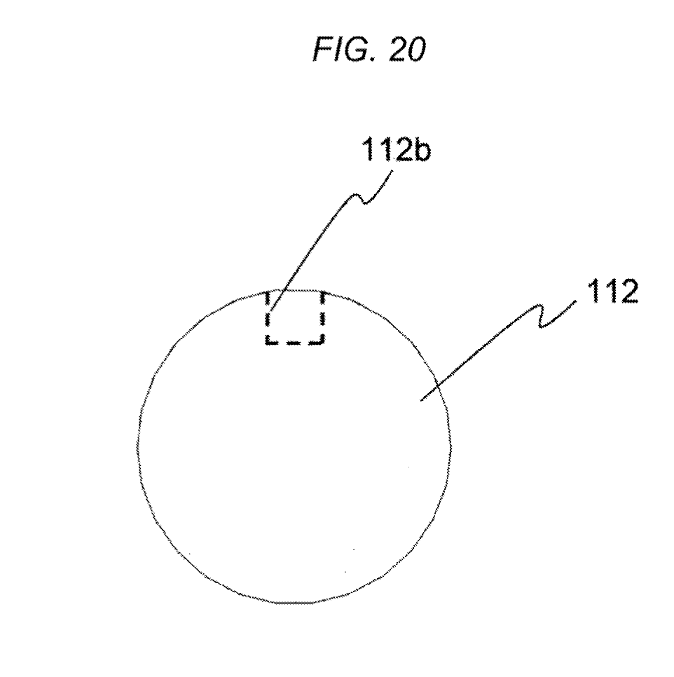

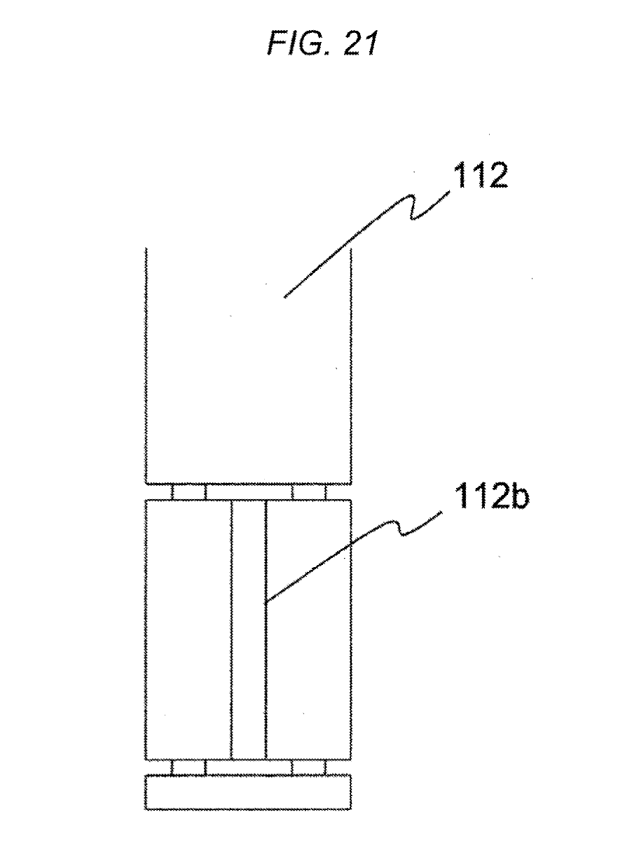

Although the truncated portion 112c is formed in the shaft 112 by way of example in the aforementioned description, alternatively, the truncated portion 112c may be substituted with a notch. A hollow 112d may be formed as illustrated in FIGS. 19 and 20, or a protrusion 112e may be formed as illustrated in FIGS. 21, 22, and 23. In such a configuration, it is possible to obtain the same effects as those of the truncated portion 112c.

### Fourth Embodiment

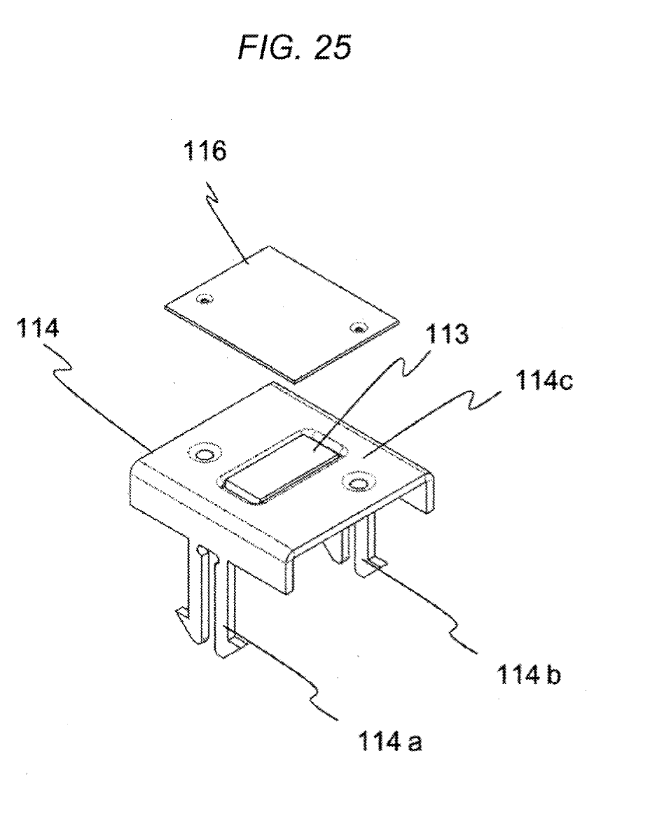

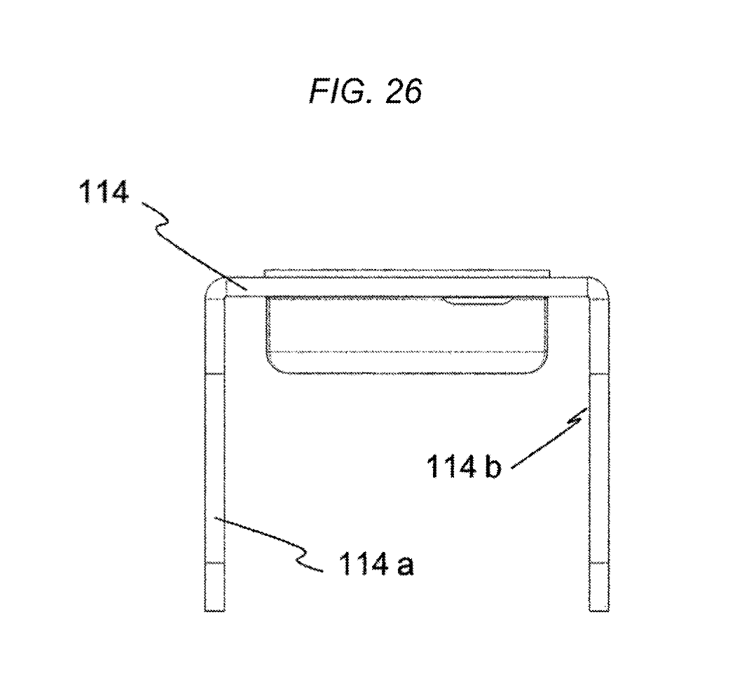

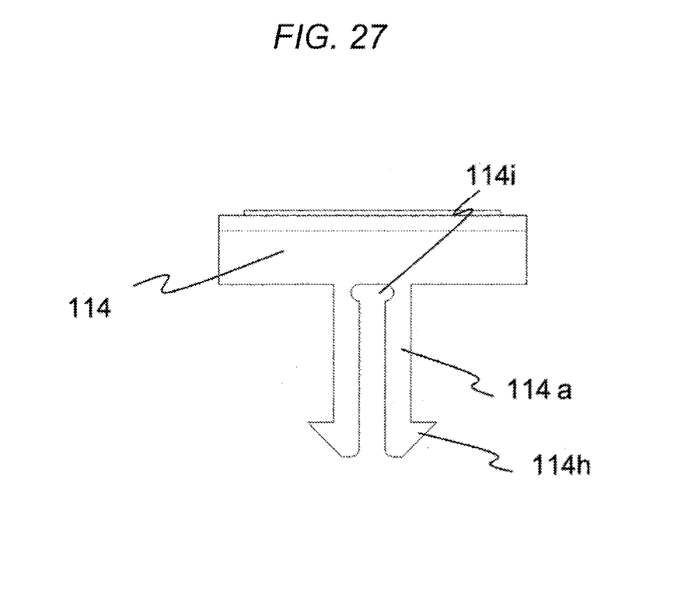

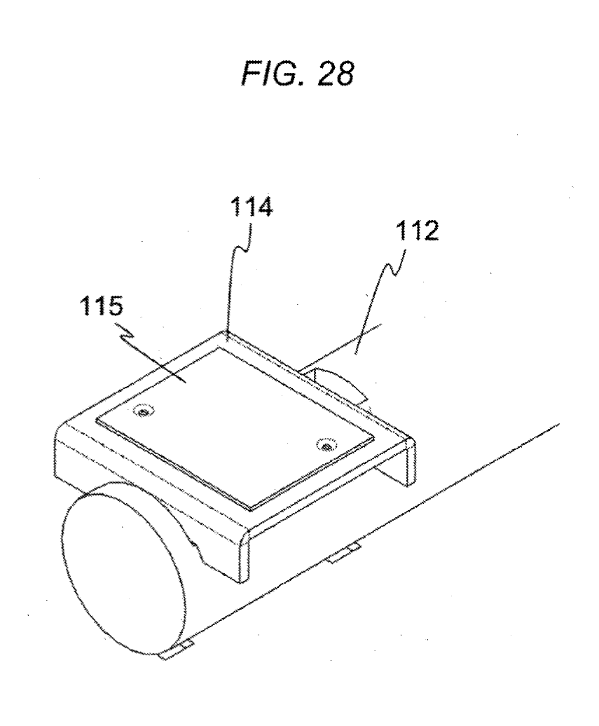

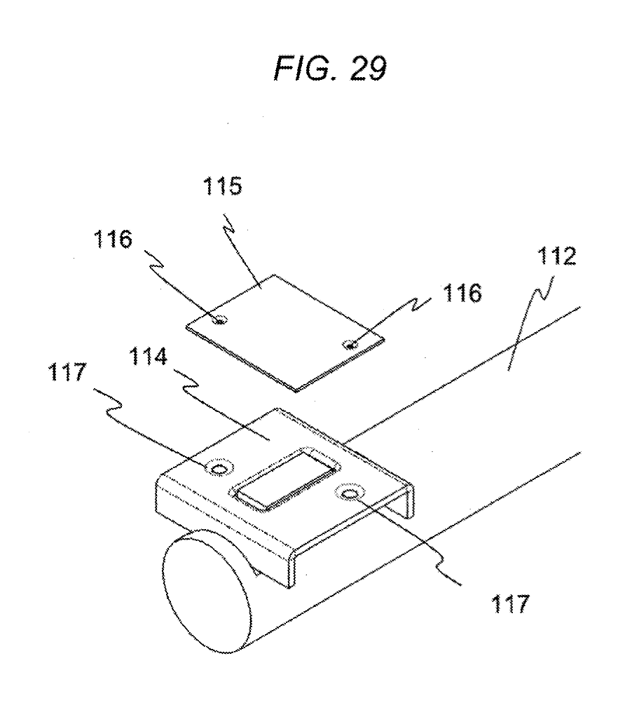

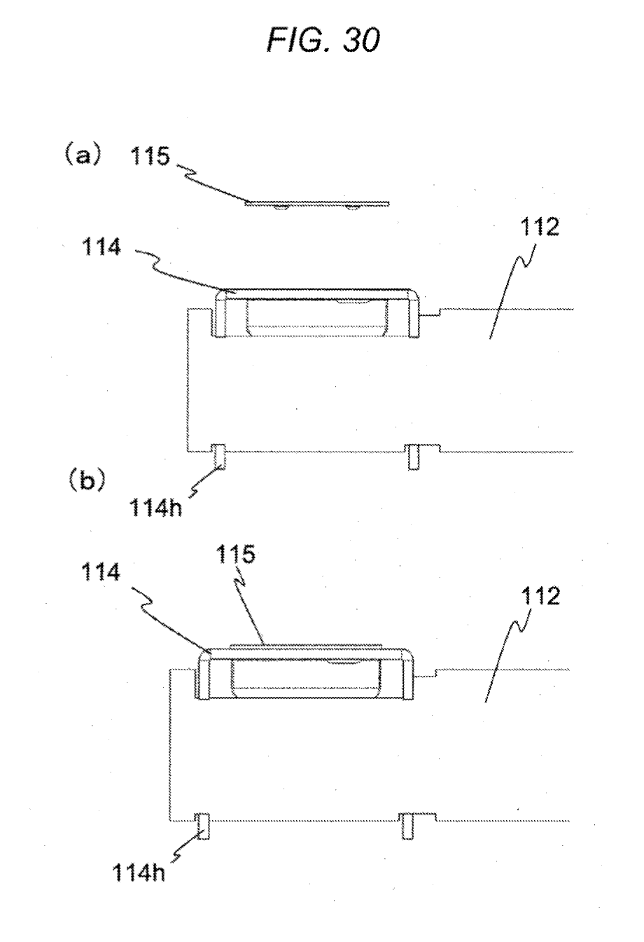

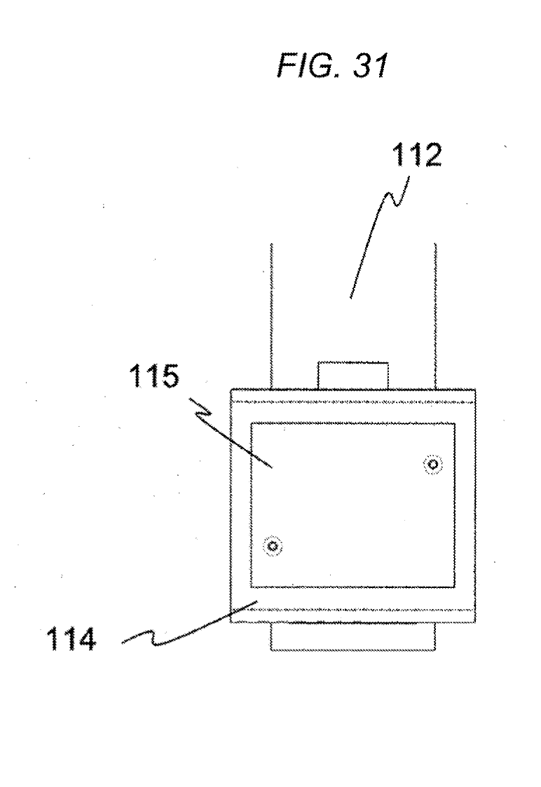

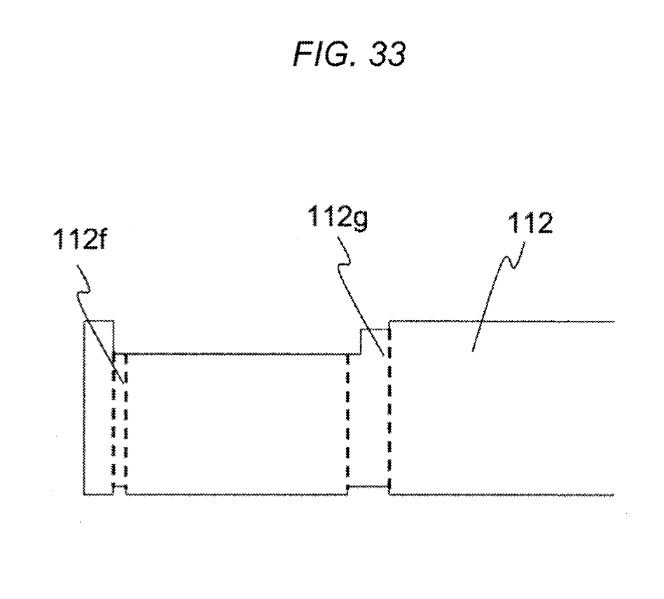

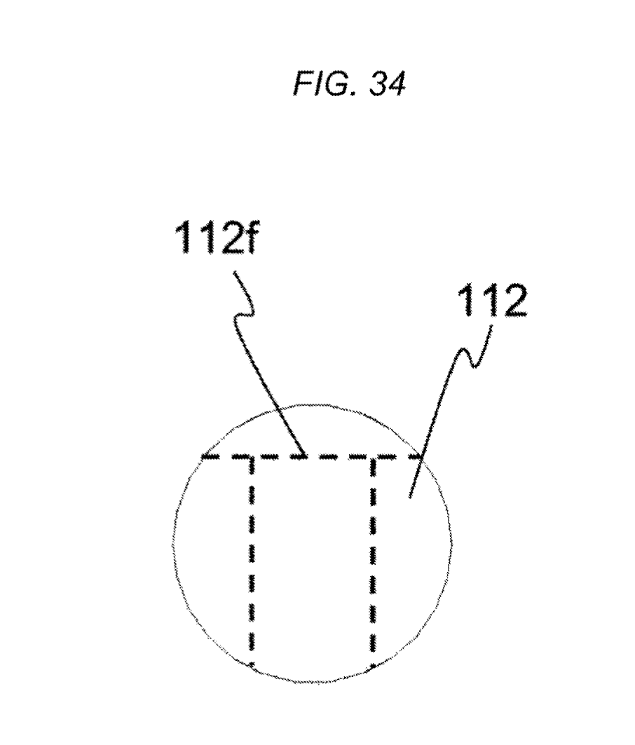

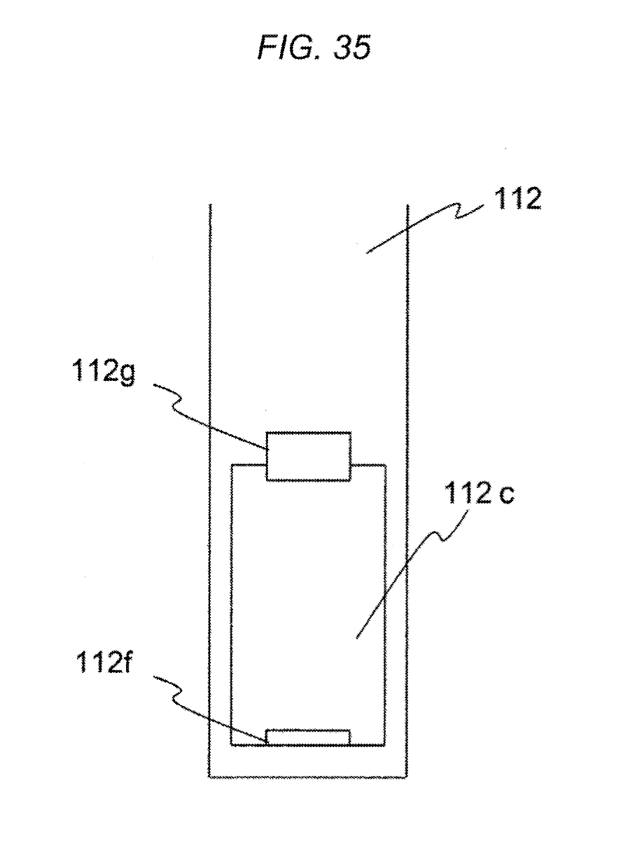

A fourth embodiment of the present invention will be described with reference to FIGS. 25 to 35. Note that like reference numerals denote like elements as in the first to third embodiments, and they will not be described repeatedly.

In this embodiment, the first and second fixing portions have shapes different from those of the first to third embodiments.

The first fixing portion 114a according to this embodiment has a pair of plates straightly extending in parallel such that they can be inserted into holes of the movable object 112 to allow fixation. In addition, tip portions 114h have a hook shape. By inserting the first fixing portion 112a into the hole of the shaft 112 and then hooking the hook shape to the shaft 112, the target 110 can be fixed to the shaft 112. In addition, the first fixing portion 112a has a base portion 112i having an R-shape which is a relief shape. By virtue of this relief shape, the first fixing portion 112a can be easily deformed when installing the target 110 in the shaft 112. Therefore, installability is improved. The second fixing portion 112b has the same shape as that of the first fixing portion.

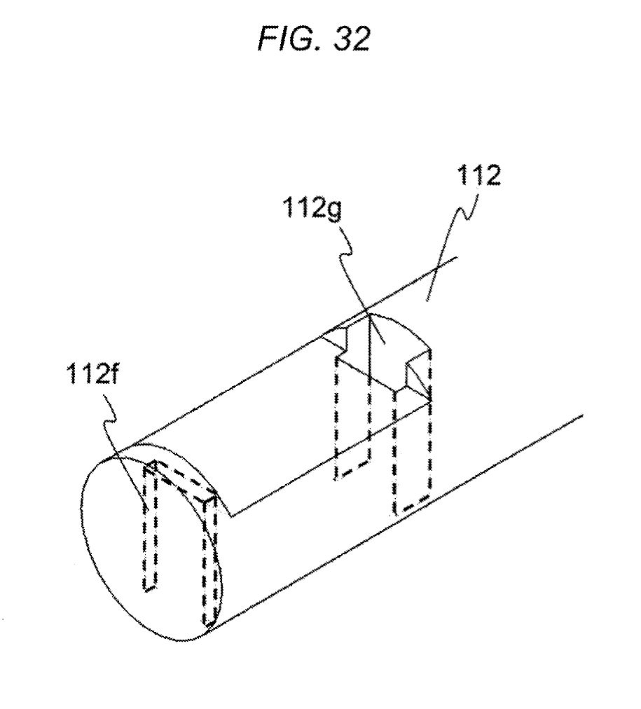

As illustrated in FIGS. 32 to 35, the shaft 112 where the target 110 is installed is provided with a truncated portion 112c, a first hole 112f, and a second hole g. By inserting the first fixing portion 112a into the first hole 112f and inserting the second fixing portion 112b into the second hole 112g, the target 110 is fixed to the shaft 112.

Here, by providing a clearance in the second hole 112g, it is possible to reduce influence of a dimensional change caused by a solid variation. Therefore, it is possible to further improve installability.

### Fifth Embodiment

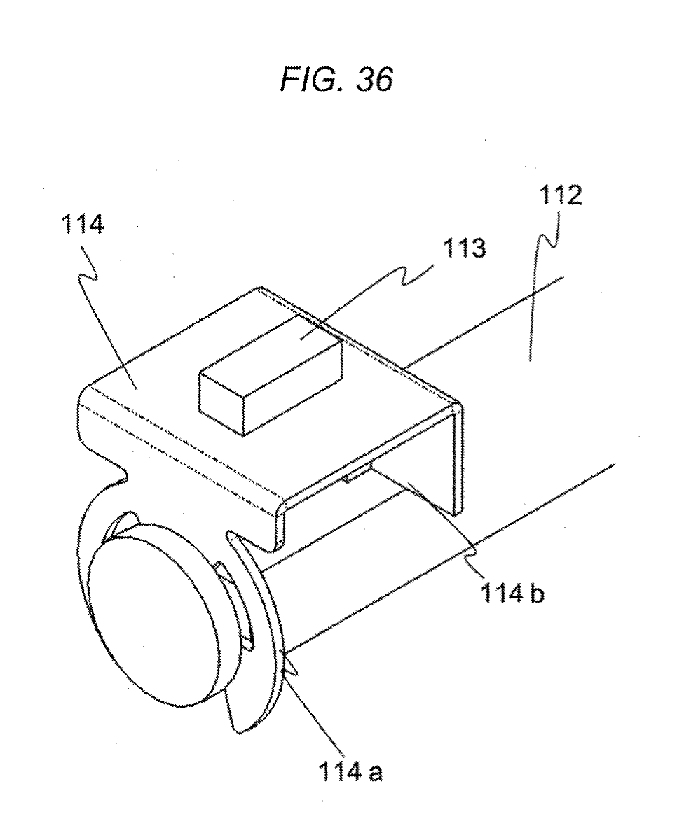

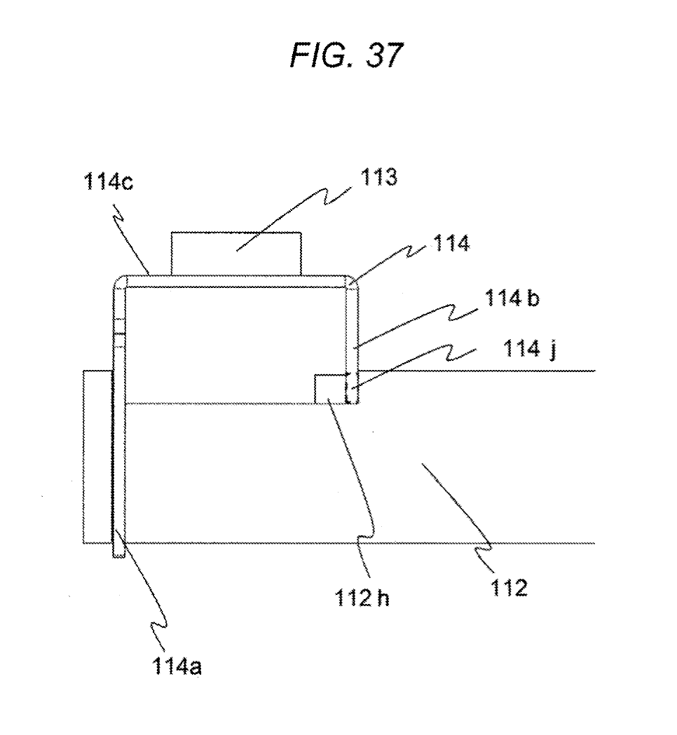

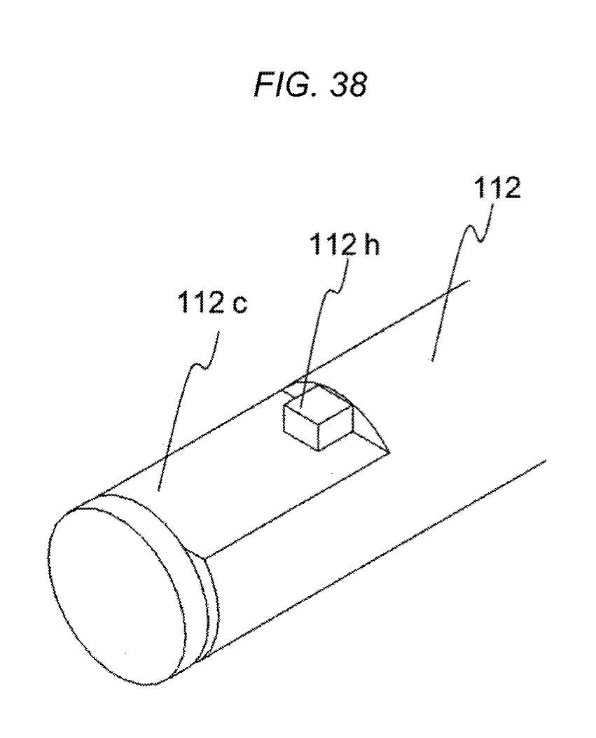

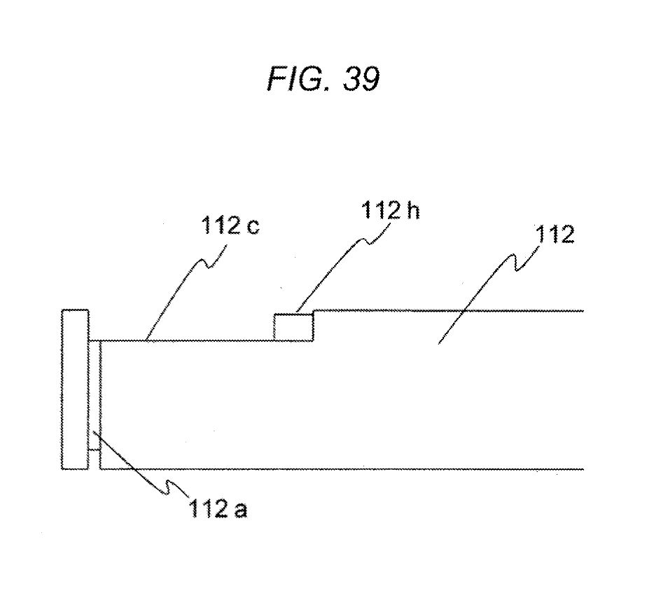

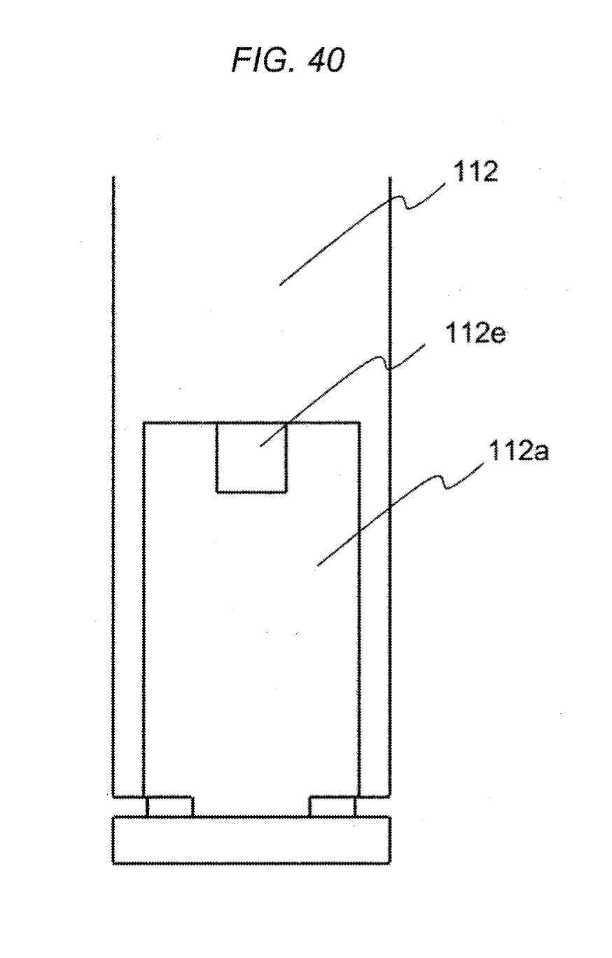

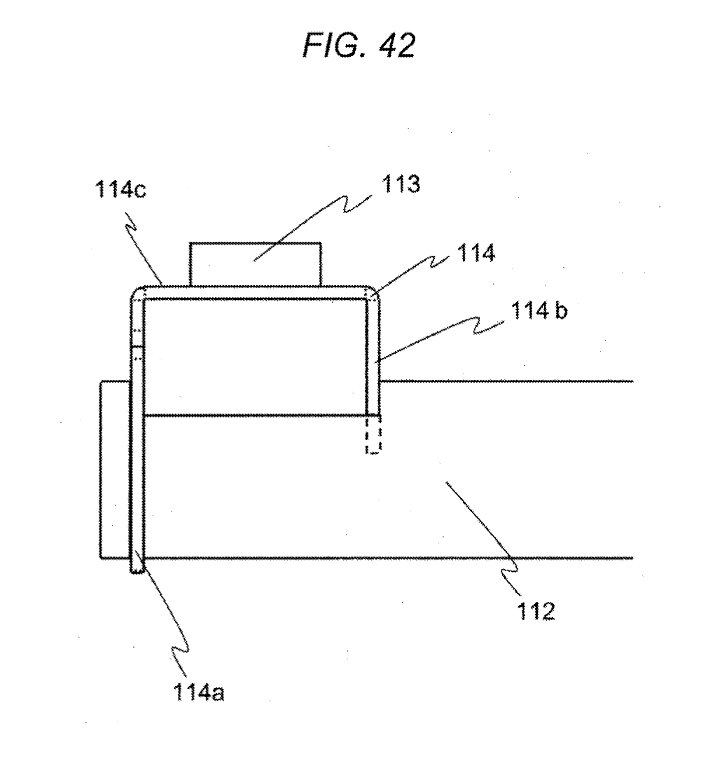

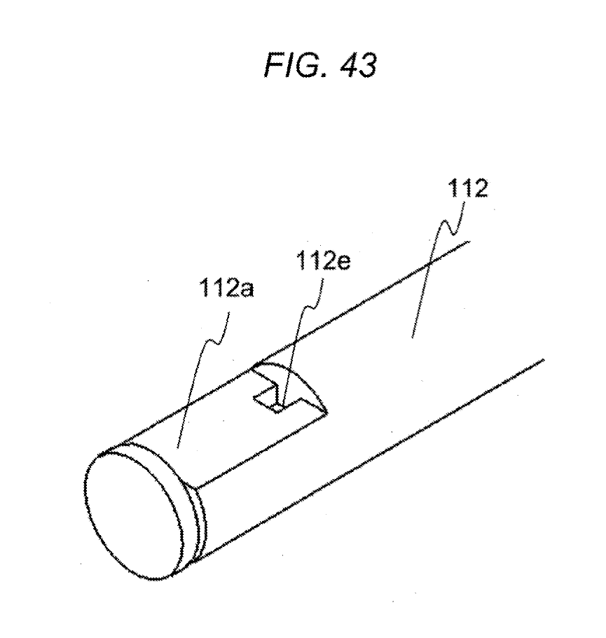

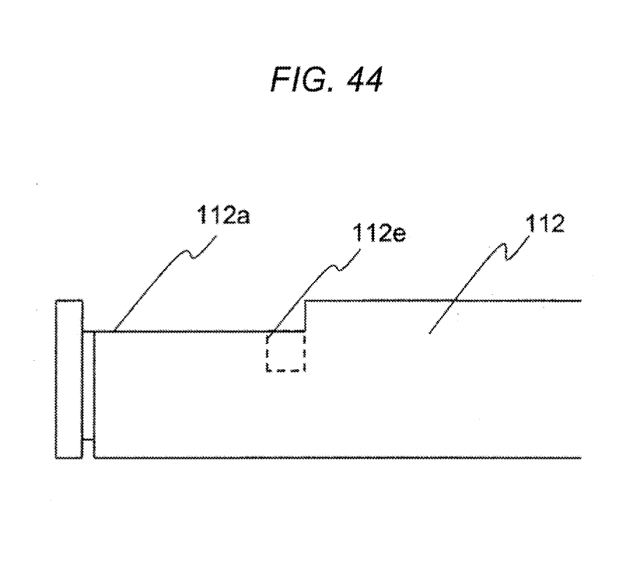

A fifth embodiment of the present invention will be described with reference to FIGS. 36 to 45. Note that like reference numerals denote like elements as in the first to third embodiments, and they will not be described repeatedly.

In this embodiment, the second fixing portion 112b has a shape different from those of the first to third embodiments.

As illustrated in FIGS. 36 to 40, the second fixing portion 112b is provided with a hollow 114j fitted to the protrusion 112h of the movable object 112. As a result, a movement in a twist direction is restricted. According to this embodiment, it is possible to fix the target 110 to the movable object 112 while simplifying the configuration of the second fixing portion 112b.

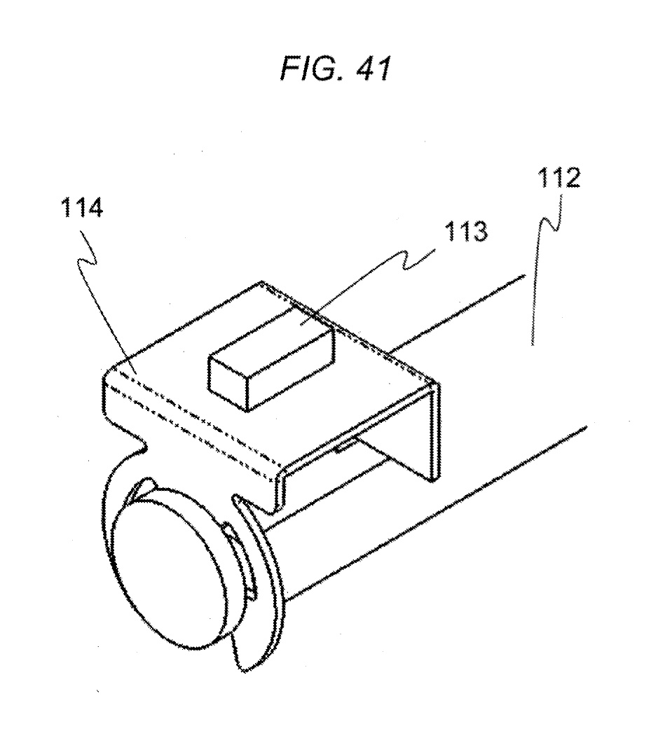

As a modification, the second fixing portion 112b is provided with a protrusion 114k fitted to the hollow 112i of the movable object 112 as illustrated in FIGS. 41 to 45.

### [Installation Example of Position Sensor]

Next, an exemplary case where the position sensor according the first embodiment is installed in the movable object 112 will be described as an installation example.

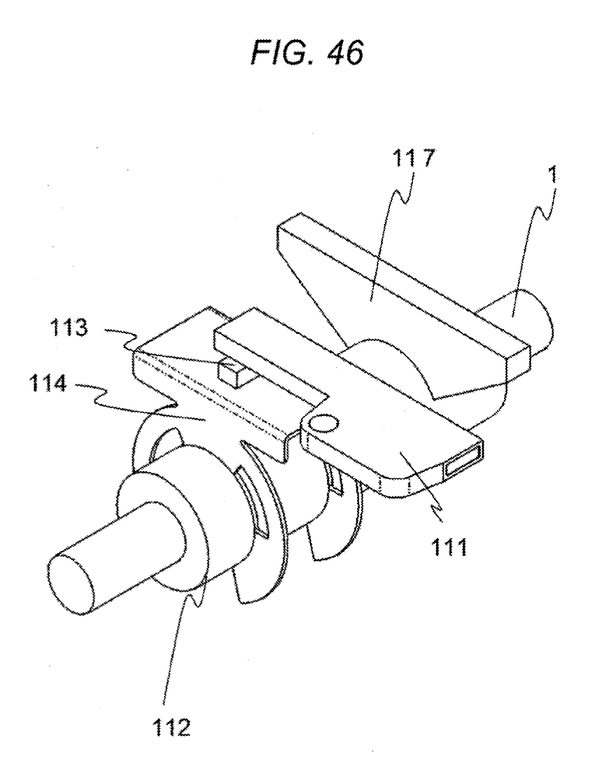

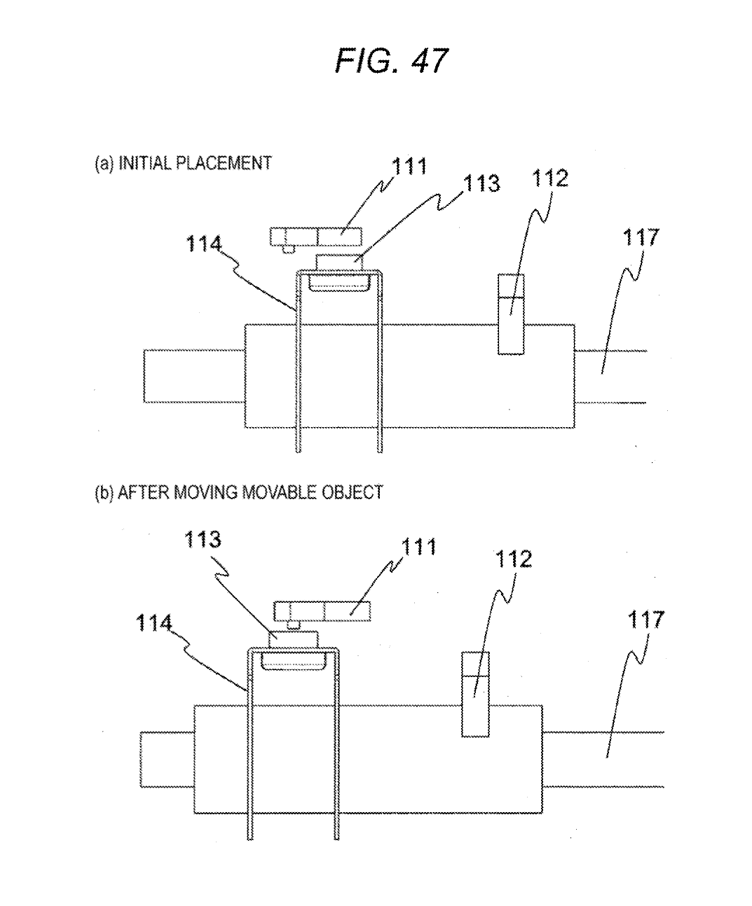

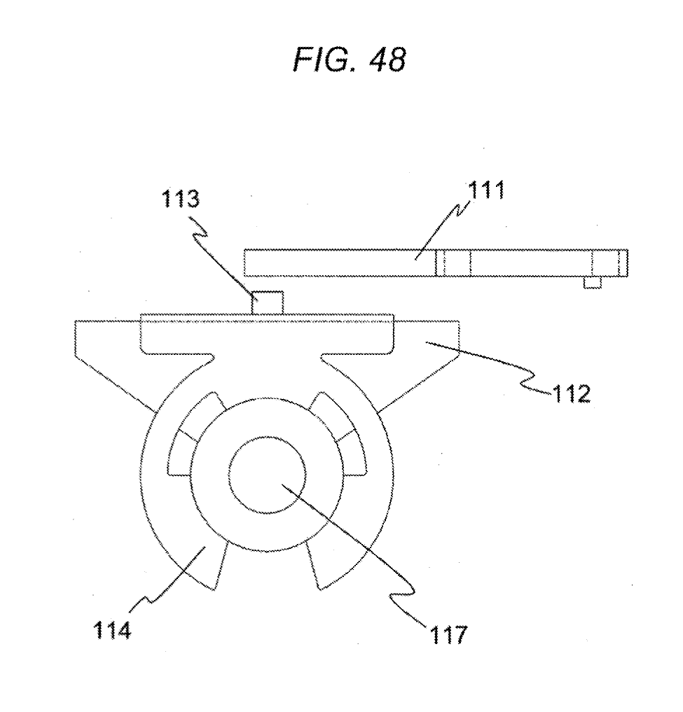

Although the position sensor is installed in the shaft in each embodiment, the target 110 according to the present invention can also be easily installed in a movable object 112 even when the movable object has a cylindrical portion provided with a cavity such as a pulley, and a shaft 1 is inserted into the cylindrical portion so that the cylindrical portion moves along the shaft as illustrated in FIGS. 46 to 48.

As an advantage of the fixing portion having a ring shape as described in the first to third and fifth embodiments, the target 110 can also be easily installed in a movable object even when the movable object has a cylindrical portion such as a pulley and a shaft is arranged inside the cylindrical portion.

According to the first to fifth embodiments of the invention, for example, even when a component that may be an obstacle in insertion of the axial direction such as the structure 117 is formed in the movable object, the target can be easily installed from a direction perpendicular to the axial direction. Therefore, it is possible to improve freedom in installation. In addition, even when such a structure is provided, it is not necessary to form an installation portion for installation on the outside in the axial direction. Therefore, this contributes to miniaturization as a whole.

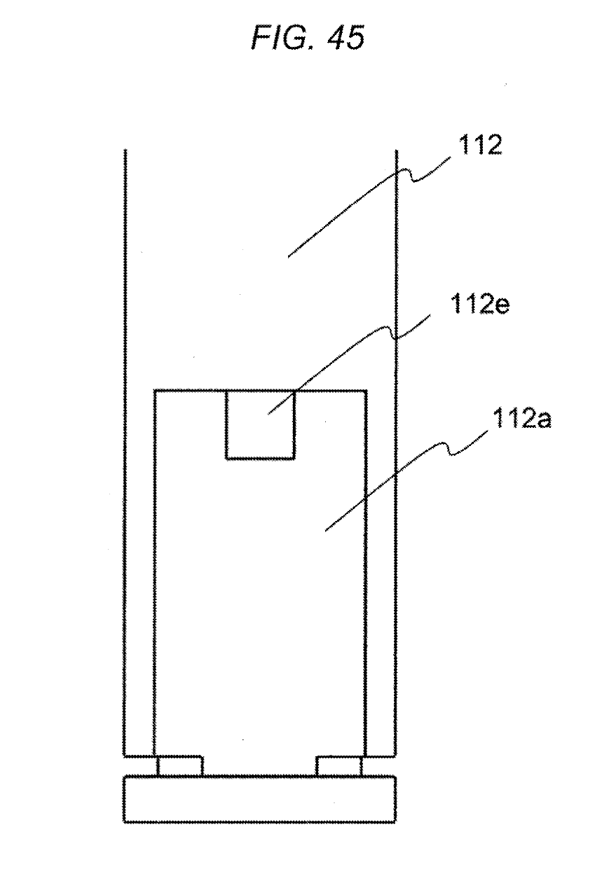

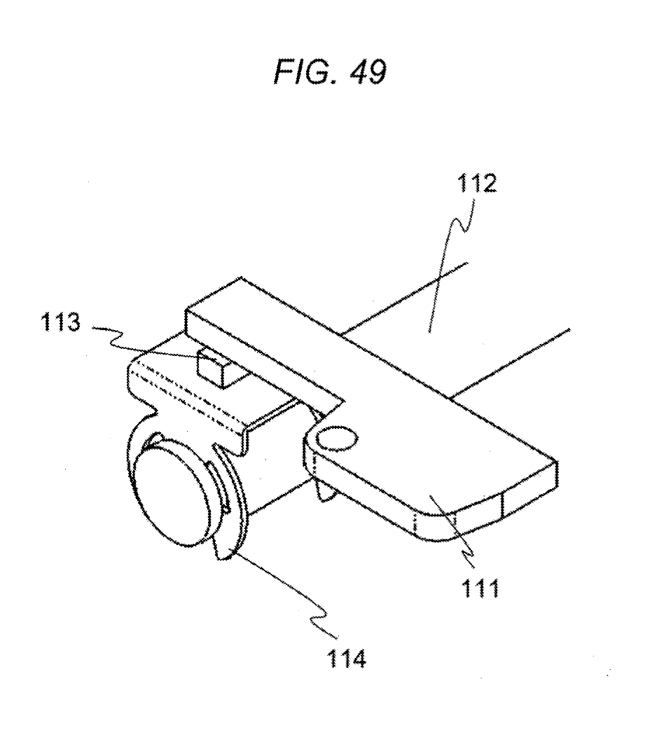

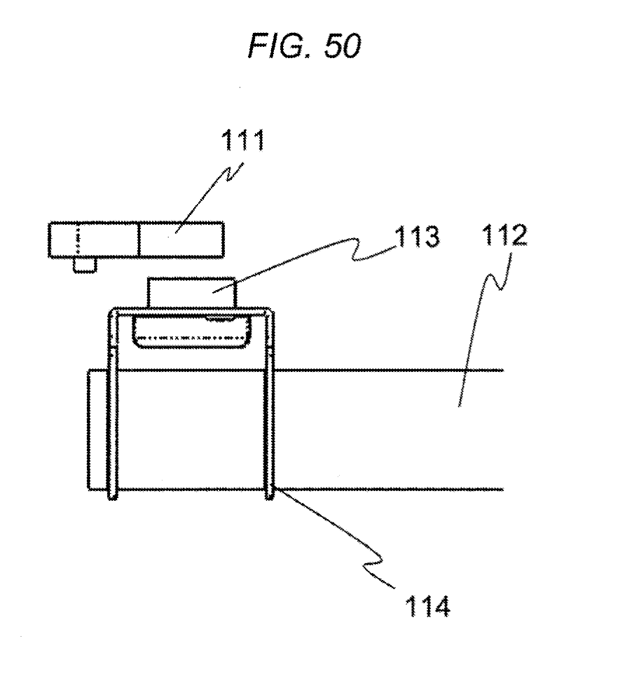

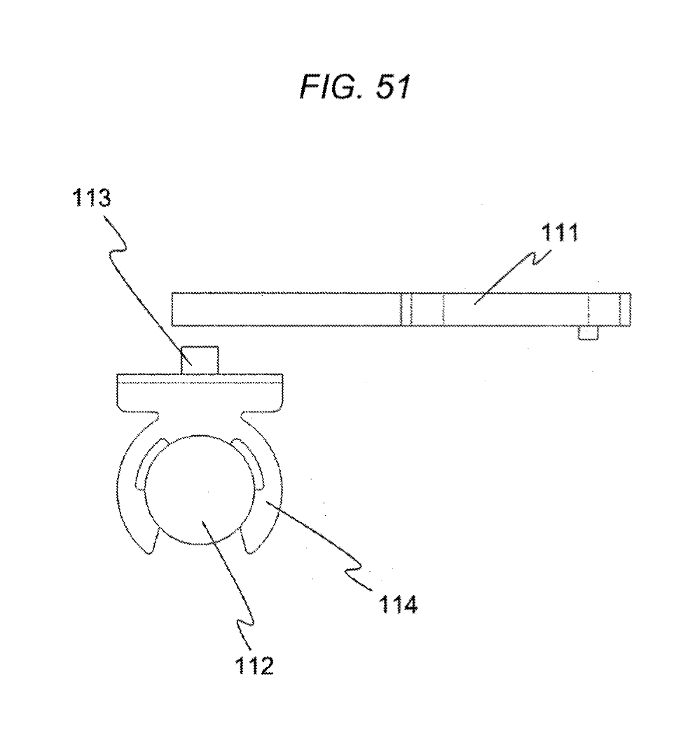

The magnetic sensor ill is arranged perpendicularly to the magnet 113 as illustrated in FIG. 1. Alternatively, the magnetic sensor 111 may be arranged in parallel with the magnet 113 as illustrated in FIGS. 45 to 51.

### REFERENCE SIGNS LIST

110 target
111 magnetic sensor
112 movable object
112a first groove
112b second groove
112c truncated portion
112d hollow
112e protrusion
112f hole
112g hole
112h protrusion
112i hollow
113 magnet
114 magnetic base
114a first fixing portion
114b second fixing portion
114c magnet holding portion
114d first contact portion
114e second contact portion
114f third contact portion
114g opening
114h tip portion
114i base portion
114j hollow
114k protrusion
115 base cover
116 positioning protrusion
117 positioning hollow

1. A position sensor comprising a magnetic sensor and a target installed in a movable object,
wherein the target has a magnet and a magnetic base that holds the magnet, and
the magnetic base has a magnet holding portion and a fixing portion for fixation to the movable object, the magnet holding portion and the fixing portion being formed integrally.

2. The position sensor according to claim 1, wherein the fixing portion has a first fixing portion and a second fixing portion.

3. The position sensor according to claim 2, wherein the first fixing portion has a partially opened ring shape.

4. The position sensor according to claim 3, wherein the first fixing portion has first, second, and third contact portions coming into contact with the movable object.

5. The position sensor according to claim 4, wherein the first contact portion is formed apart from the opening,
the second and third contact portions are formed in the opening side,
the first contact portion is shaped to have a flat portion, and
the second and third contact portions have an arc shape.

6. The position sensor according to claim 5, wherein the first fixing portion has
a first non-contact portion that does not come into contact with the movable object between the first and second contact portions, and
a second non-contact portion that does not come into contact with the movable object between the first and second contact portions.

7. The position sensor according to claim 6, wherein an opening of the first fixing portion has a tapered shape gradually narrowing from an opening end to an inner side.

8. The position sensor according to claim 4, wherein the second fixing portion has a shape similar to that of the first fixing portion.

9. The position sensor according to claim 4, wherein the second fixing portion is shaped to have a protrusion fitted into a hollow formed in the movable object or a hollow fitted into a protrusion formed in the movable object.

10. The position sensor according to claim 3, wherein the movable object has a groove formed along a circumferential direction, and
the target is fixed to the movable object by fitting the fixing portion into the groove.

11. The position sensor according to claim 8, wherein the movable object has first and second grooves formed along a circumferential direction,
the first groove has a partially flattened portion,
the target is fixed to the movable object by fitting the first fixing portion into the first groove and fitting the second fixing portion into the second groove, and
the first contact portion comes into contact with the flattened portion.

12. The position sensor according to claim 8, wherein the movable object has first and second grooves formed along a circumferential direction,
a flattened flat portion is formed between the first and second grooves,
the target is fixed to the movable object by fitting the first fixing portion into the first groove and fitting the second fixing portion into the second groove, and
the magnet holding portion is fixed in a position facing the flat portion.

13. The position sensor according to claim 1, further comprising a base cover that covers the magnet,
wherein the magnetic base has a housing hollow formed in the magnet holding portion, and
the magnet is disposed in the hollow.

14. The position sensor according to claim 1, further comprising a base cover that covers the magnet,
wherein the base cover is provided with a housing hollow that houses the magnet.

15. The position sensor according to claim 13, wherein the magnetic base is provided with a hollow or a protrusion that matches a positioning protrusion or a positioning hollow formed in the base cover.

16. The position sensor according to claim 2, wherein the first and second fixing portions have a tip having a hook shape for fixing the target.

17. The position sensor according to claim 16, wherein the movable object has a partially flattened portion on its side surface,
the flattened portion is provided with first and second holes,
the target can be fixed to the movable object by inserting the first fixing portion into the first hole, inserting the second fixing portion into the second hole, and hooking the hook shape in the movable object, and
one of the first and second holes is shaped to have a clearance.

18. A target installed in a movable object moving in an axial direction and provided with a magnet that generates a magnetic force detected by a magnetic sensor,
wherein the target has a magnetic base for holding the magnet, and
the magnetic base has a magnet holding portion and a fixing portion for fixation to the movable object, the magnet holding portion and the fixing portion being formed integrally.

19. The target according to claim 18, wherein the fixing portion has first and second fixing portions,
the first fixing portion has a partially opened ring shape,
an opening of the first fixing portion has a tapered shape gradually narrowing from an opening end to an inner side,
the first fixing portion has
first, second, and third contact portions coming into contact with the movable object,
a first non-contact portion that does not come into contact with the movable object between the first and second contact portions, and
a second non-contact portion that does not come into contact with the movable object between the first and second contact portions,
the first contact portion is formed apart from the opening,
the second and third contact portions are formed in the opening side,
the first contact portion is shaped to have a flat portion,
the second and third contact portions have an arc shape, and
the second fixing portion has a shape similar to that of the first fixing portion.
